(19) United States
(12) Patent Application Publication
(10) Pub. No.: US 2007/0108745 A1
(43) Pub. Date: May 17, 2007

(54) SIDE IMPACT AIRBAG

(75) Inventors: James Belwafa, Ann Arbor, MI (US); Karen Balavich, Lake Orion, MI (US); Brian Spahn, Plymouth, MI (US); Irmina Reyes-Helfrich, Birmingham, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/164,304

(22) Filed: Nov. 17, 2005

(51) Int. Cl. B60R 21/16

(52) U.S. Cl. 280/730.2

(57) ABSTRACT

A side impact airbag for a vehicle is deployed from a vehicle seat back in a forward direction. The airbag has a primary inflation chamber that when fully inflated is rearward of the coronal plane that extends through a seated occupant's hip and shoulder. A supplemental inflation chamber may be provided forward of the primary inflation chamber.

### BACKGROUND OF THE INVENTION

1. Field of the Invention

The present invention relates to side impact airbags for vehicles.

2. Background Art

Vehicle airbags are used to protect vehicle occupants in the event of a collision. Airbags were initially provided on the dashboard and steering wheel of vehicles to protect against front end collisions. More recently, side impact airbags have been developed to protect vehicle occupants in the event of a side impact. Side impact airbags are inflated by means of an inflator that inflates the airbag with a gaseous medium when an impact is detected by side impact sensors provided on the vehicle.

Some prior art side impact airbags when inflated extend from a mounting location on one side of a seat back forwardly between the vehicle door and the occupant to cover the entire side of an occupant's body. This type of side impact airbag, when deployed, extends across the coronal plane of an occupant's body. The coronal plane is a line extending between a person's hip and shoulder. Generally, the widest part of a person's body corresponds to the coronal plane.

A side impact airbag may be inflated to place a cushion between a vehicle body part that may intrude into the passenger cabin and a person's body in the event of an impact. Side impact airbags inflate very rapidly while the intruding structure of the vehicle body is moving toward the vehicle occupant.

One problem with such prior art side impact airbags is that the combined force of the intruding structure and the force of the side impact airbag inflation may actually not reduce the lateral forces applied to an occupant's body. There is a need for an effective side impact airbag that effectively reduces the load that an occupant will experience.

An additional problem is that the greater the volume of the airbag, the more time is required to deploy the airbag. Larger volume airbags also require larger inflators. Increasing the size of a side impact airbag and its associated inflator also increases the cost of the side impact airbag system. There is a need for a side impact airbag that reduces the time required for full deployment and reduces system cost.

One test developed for side impact airbags is the IIHS high hooded barrier side impact test. It is desirable to develop side impact airbags that meet this IIHS test without degrading test performance according to other test procedures. There is a need to develop side impact airbags that meet all of the requirements of any and all such tests.

There is a need to provide a side impact airbag having a shape that is optimized to manage intruding energy, but not overload the occupant. There is also a need to provide a side impact airbag that loads bio-mechanically appropriate areas of the body to start moving the occupant away from the intrusion sooner than prior art side impact airbags.

Applicants' invention is directed to solving the above problems and fulfilling the above needs as summarized below.

### SUMMARY OF THE INVENTION

According to one aspect of the present invention, a side impact airbag system is provided for a vehicle having a seat. The seat includes a seat back that has an attachment structure and deployment opening. The system comprises an inflator and an airbag that is attached to the seat back of the vehicle seat. The airbag has a primary inflation chamber that extends from the attachment structure in the forward direction to a limited extent. The primary inflation chamber extends forwardly to a point that is rearward of a coronal plane that is defined as a line extending from a shoulder to a hip of the vehicle occupant.

According to other aspects of the invention, a supplemental inflation chamber may be provided that is disposed forward of the primary inflation chamber. The supplemental inflation chamber is inflated by the inflator along with the primary inflation chamber. The primary inflation chamber, when inflated, has a lateral width that is greater than the supplemental inflation chamber. For example, the supplemental inflation chamber may be less than half of the lateral width of the primary inflation chamber.

According to other aspects of the invention as it relates to a side impact airbag system, the primary inflation chamber may engage the occupant at a location rearward of the coronal plane to apply a force to the occupant causing the occupant to move away from the side of the vehicle adjacent the seat. A primary inflation chamber may be cylindrical when inflated or may be oblong or irregularly shaped. The inflator may be attached to the airbag and an attachment structure on the seat back.

According to another aspect of the present invention, a passive restraint vehicle occupant protection system is provided. The vehicle body may have an impact protection area and a sensing system for sensing an impact to the impact protection area. An inflator is provided that may be selectively activated by the sensing system in response to the sensing system sensing an impact. The airbag is inflated by the inflator and is disposed to move an occupant away from the impact protection area. The airbag, when inflated, is disposed generally between the impact protection area and the occupant's body, and extends from the seat back and only up to the coronal plane of the occupant's body.

According to other aspects of the invention as they relate to the airbag system, the impact protection area is a side of the vehicle and the airbag is a side impact airbag. The coronal plane of an occupant's body extends through the occupant's hip and shoulder. The airbag, when inflated, is spaced rearwardly from the coronal plane.

According to other aspects of the invention, a foreign body impacting the vehicle in the impact protection area may cause a portion of the vehicle body to intrude into the vehicle interior toward the occupant. The airbag is positioned so that it inflates and has a maximum width that is located behind the coronal plane.

These and other aspects of the invention will be better understood and readily apparent in view of the attached drawings and the following detailed description of the illustrated embodiments.

### BRIEF DESCRIPTION OF THE DRAWINGS

FIG. 1 is a diagrammatic side elevation view of a person in a vehicle seat having a side impact airbag made in accordance with one embodiment of the present invention;

FIG. 2a is a cross-sectional view of the side impact airbag of the present invention with an interrupted seam to divide the airbag into a primary and a secondary inflation chamber that is taken along the line 2a-2a in FIG. 1 and is shown in conjunction with a diagrammatic view of a seated person;

FIG. 2b is a cross-sectional view similar to the section of FIG. 2a but showing a tether that is used to divide the airbag into a primary and a secondary inflation chamber;

FIG. 3 is a diagrammatic side elevation view of an alternative embodiment of a side impact airbag and a person seated in a vehicle seat;

FIG. 4 is a cross-sectional view taken the line 4-4 in FIG. 3; and

FIG. 5 is a cross-sectional view taken along the line 5-5 in FIG. 3.

### DETAILED DESCRIPTION OF THE PREFERRED EMBODIMENT(S)

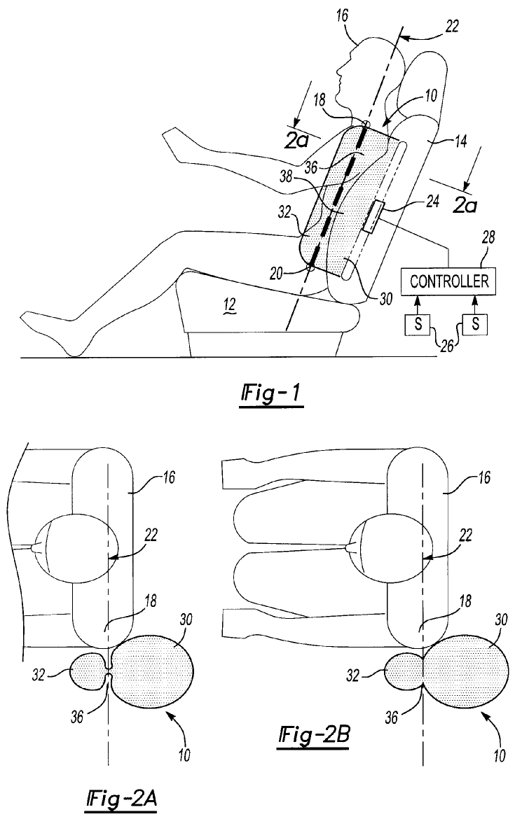

Referring to FIGS. 1 and 2, an airbag 10 is shown in its deployed condition in conjunction with a vehicle seat 12. Vehicle seat 12 has a seat back 14 in which the airbag 10 is stored until it is ready to be deployed.

An occupant 16 is shown seated in the vehicle seat 12. A shoulder 18 and hip 20 of the occupant 16 are indicated with an axis line representative of a coronal plane 22 being illustrated that extends through the shoulder 18 and the hip 20 of the occupant 16. The coronal plane 22 is a planar section taken through a person's body at the shoulder 18 and hip 20, or h-point, that generally corresponds to the widest portions of the occupant's body.

An inflator 24 may be provided at any height on the seat back 14. The inflator 24 rapidly expels a gaseous medium into the airbag 10 in the event of a side impact. A side impact may be detected by sensors 26 that are disposed on the vehicle body at various locations. The sensors 26 provide a signal to a controller 28 in the event of a side impact. The controller 28 signals the inflator 24 to deploy the airbag 10.

The airbag 10 has a primary inflation chamber 30 that, when inflated, expands to a point rearward of the coronal plane 22. Upon inflation, the primary inflation chamber 30 engages the occupant 16 generally behind the occupant's shoulder 18 and hip 20 causing the occupant 16 to move inwardly toward the center of the vehicle and away from the side of the vehicle that is subject to the side impact. The airbag 10 can be made in a range of sizes to cover an occupant's shoulder, thorax, abdomen and pelvis. Alternatively, any one of the listed anatomical regions may be covered or combinations of adjacent regions may be covered by the airbag 10.

A secondary inflation chamber 32 may be provided, if desired, to provide a reduced width cushion between the occupant's body 16 that extends across the coronal plane 22. The secondary inflation chamber 32 may be separated from the primary inflation chamber 30 at 36 by either an interrupted seam or a tethered area. If an interrupted seam is provided at 36, as shown in FIG. 2a, a plurality of air passages 38 are provided through which the gaseous medium emitted by the inflator 24 flows to inflate the secondary inflation chamber 32 in conjunction with the inflation of the primary inflation chamber 30. Alternatively, if a tethered area is provided at 36, as shown in FIG. 2b, gas flow is provided to the secondary inflation chamber through less restricted air passages 38.

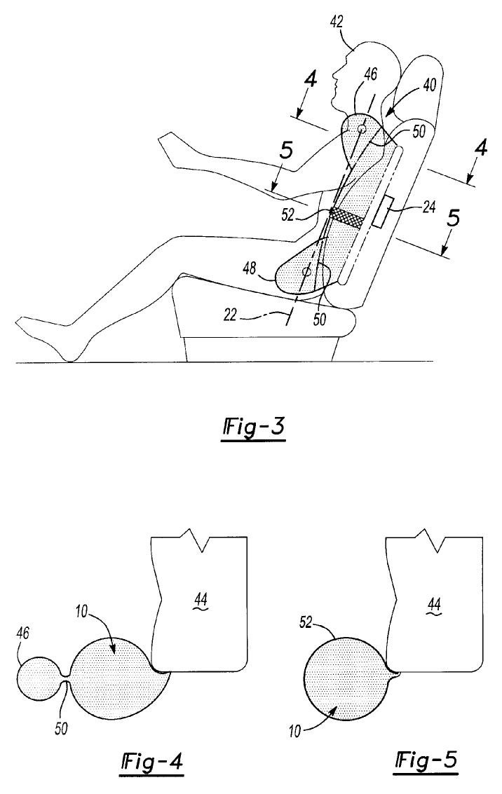

Referring to FIGS. 3 through 5, an alternative embodiment of an airbag 40 is illustrated in its deployed condition. The airbag 40 is shown in conjunction with diagrammatic representation of an occupant 42 seated in a vehicle seat 44. The airbag 40 is deployed in a manner similar to the deployment of airbag 10 described above. For brevity, the description of the deployment process is not repeated for the embodiment of airbag 40.

A supplemental shoulder extension 46 and supplemental hip extension 48 are provided forward of the airbag 40. The illustrated extensions 46, 48 are relatively short, but could be substantially longer, if desired. The supplemental shoulder extension 46 and supplemental hip extension 48 are separated from the airbag 40 by interrupted seams 50. The supplemental shoulder and hip extensions 46 and 48, while differently shaped, function in a manner similar to the secondary inflation chamber 32 of the embodiment of FIGS. 1 and 2. The interrupted seams 50 allow the gaseous medium to flow from airbag 40 into the shoulder and hip extensions 46 and 48.

The supplemental shoulder and hip extensions 46 and 48 is less than the width of the airbag 40. When the airbag 40 is inflated, it engages the body of an occupant behind the coronal plane 22 to urge the occupant's body toward the center of the vehicle and away from the side impact location. The supplemental shoulder and hip extensions 46 and 48 provide a buffer adjacent an occupant's shoulder and hip.

A tether 52 may be provided to divide the airbag 40 into differently pressurized zones. The tether 52 may be oriented at different angles depending upon vehicle design considerations.

While the best mode for carrying out the invention has been described in detail, those familiar with the art to which this invention relates will recognize various alternative designs and embodiments for practicing the invention as defined by the following claims.

What is claimed is:

1. A side impact airbag system for a vehicle having a seat, the seat includes a seat back that has an attachment structure and a deployment opening, the airbag system being provided to protect an occupant of the vehicle that is seated in the seat, the system comprising:
an inflator;
an airbag attached to the seat back of the vehicle seat that has a primary inflation chamber that extends from the attachment structure forward to an extent that is rearward of a coronal plane that is defined as a line extending from a shoulder to a hip of the occupant.

2. The side impact airbag system of claim 1 further comprising a supplemental inflation chamber that is disposed forward of the primary inflation chamber and is inflated by the inflator along with the primary inflation chamber, the primary inflation chamber being inflatable to a lateral width that is greater than the supplemental inflation chamber.

3. The side impact airbag system of claim 2 wherein the supplemental inflation chamber is less than half of the lateral width of the primary inflation chamber.

4. The side impact airbag system of claim 1 wherein the primary inflation chamber engages the occupant at a location rearward of the coronal plane and applies a force to the occupant to move the occupant away from a side of the vehicle adjacent the seat.

5. The side impact airbag system of claim 1 wherein the primary inflation chamber is cylindrical when inflated.

6. The side impact airbag system of claim 1 wherein the inflator is attached to the airbag and the attachment structure of the seat back.

7. A passive restraint vehicle occupant protection system, comprising:
a vehicle body having an impact protection area;
a sensing system for sensing an impact to the impact protection area;
an inflator that may be selectively activated by the sensing system in response to the sensing system sensing an impact;
an airbag that is inflated by the inflator, the airbag being disposed to move an occupant away from the impact protection area, the airbag when inflated being disposed generally between the impact protection area and the occupant's body but not directly between the impact protection area and the coronal plane of the occupant's body.

8. The passive restraint airbag system of claim 7 wherein the impact protection area is a side of the vehicle and the air bag is a side impact air bag, the coronal plane extending through the occupant's hip and shoulder, wherein the airbag when inflated is spaced rearwardly from the coronal plane.

9. The passive restraint airbag system of claim 7 wherein the airbag when inflated contacts a portion of the occupant's body that is inboard of the next adjacent portion of the occupant's body.

10. The passive restraint airbag system of claim 7 wherein the airbag is positioned when inflated has a maximum width that is located behind the coronal plane.

11. The passive restraint airbag system of claim 7 wherein the airbag is a primary inflation chamber and wherein a supplemental inflation chamber is disposed forward of the primary inflation chamber and is inflated by the inflator along with the primary inflation chamber, the primary inflation chamber being inflatable to a lateral width that is greater than the supplemental inflation chamber and the supplemental inflation chamber being disposed directly between the impact protection area and the next adjacent part of the occupant's body.

12. The passive restraint airbag system of claim 11 wherein the supplemental inflation chamber is less than half of the lateral width of the primary inflation chamber.
